(19) United States
(12) Patent Application Publication
(10) Pub. No.: US 2003/0037279 A1
(43) Pub. Date: Feb. 20, 2003

(54) HDD data backup and recovery method

(76) Inventor: Jui-Min Laio, Chang-Hua Hsien (TW)

Correspondence Address: Rabin & Champagne, P.C., Suite 500, 1101 14 th Street, Washington, DC, 20005, US

(21) Appl. No.: 09/928,394

(22) Filed: Aug. 14, 2001

(51) Int. Cl. H04L 1/22

(52) U.S. Cl. 714/6

(57) ABSTRACT

An HDD data backup and recovery method first detects available space in each partition of the HDD when the computer system is turned on. A specific storage means is employed to back up important files in the OS in the available space. When the OS is damaged and cannot operate, the backup OS data can be immediately restored to the original storage location. Through this method, damaged files can be recovered, and the OS can be started normally.

### BACKGROUND OF THE INVENTION

1. Field of Invention

The present invention relates to an HDD (Hard Disk Drive) data backup and recovery method, and in particular to a method that can immediately restore HDD data.

2. Related Art

Currently, the computer OS (Operation System) is normally stored in the main HDD partition. When the computer BIOS starts, the OS is retrieved from the main HDD partition through an IDE or SCSI connection interface and started. If some part of the data in the OS is damaged so that it cannot be executed, the computer cannot perform the operations for the relevant commands or software. One of the most commonly used solutions is to back up the OS to a floppy disk or a CD-ROM. When the mainboard of the computer is unable to start the OS from the HDD, the disk with the backup OS is then used to start the computer.

However, this method of using an additional storage device to store the OS is inconvenient for users who are not familiar with the operation environment of the computer OS and file types. Therefore, when the computer OS is damaged and no backup OS is available, normal users often have to consult the original manufacturer. Sending the computer back to the manufacturer or asking for help from professionals will always cost a lot of time and money.

In light of the foregoing, it is highly desirable to provide a method that enables the computer to automatically solve the problem of a damaged OS so that the user can continue using the computer without help from others.

### SUMMARY OF THE INVENTION

An objective of the invention is to provide a method that can immediately restore a damaged OS or important files so that the computer can boot normally, giving the user a more complete and convenient operating system.

To achieve the foregoing objective, the disclosed method includes the following steps.

Analyze the HDD Partition Table.

Determine whether data backup should be performed. If no backup data exists in the HDD, then select a partition for storing the backup data. The data to be backed up are then stored in the partition through a storage means.

Determine whether the OS is damaged. That is, check the integrity of the OS. Restore the previous backup data to where the original copy of the OS is located if the original copy of the OS is damaged and unable to start.

The foregoing method can be directly built into the extension BIOS. Before the computer OS is started, a program involving this method is first started. Therefore, detection, backup and recovery can be completed without the need of any other specific OS. The computer directly completes the OS maintenance and recovery.

### BRIEF DESCRIPTION OF THE DRAWINGS

FIG. 1 is a logic diagram of an HDD data backup and recovery method in accordance with the present invention;

FIGS. 2A through 2D are schematic diagrams of a first embodiment of the HDD data backup and recovery method in FIG. 1;

FIGS. 3A through 3D are schematic diagrams of a second embodiment of the HDD data backup and recovery method in FIG. 1; and

FIGS. 4A through 4D are schematic diagrams of a third embodiment of the HDD data backup and recovery procedure in FIG. 1.

### DETAILED DESCRIPTION OF THE INVENTION

The HDD data backup and recovery method in accordance with the invention pertains to a method that can automatically back up OS data for later use to recover the data to a main HDD partition when appropriate. The method includes the following steps:

(1) Read the HDD partition table.

(2) Analyze the HDD partition table. Perform a detailed analysis on the capacity and available space of each partition.

(3) Determine whether data backup should be performed. Determine whether two identical OS's exist in the HDD. If not, then select an appropriate partition and store the backup data in the selected partition through a storage means.

(4) Determine whether the OS is damaged. Check the integrity of the OS. Restore the previous backup data to where the original copy of the OS is located if the original copy of the OS is damaged and unable to start.

(5) Start the OS restored in the main partition.

The foregoing lists the main procedures of the disclosed method. In step (3), when determining whether data backup should be performed and storing data in a selected partition, any of the following methods can be used:

1. Decrease the size of a partition. Sufficient space in accordance with the backup data amount is spared in the partition suitable for storing the backup data. Once the partition stores the backup data, its capacity appears less than before.

2. Bad track tags. The sectors or tracks that store the backup data are tagged as bad sectors or tracks.

3. Set hidden/read only attributes. Once the backup data is stored in a specific sector, the file allocation table of the sector is modified according to the file system used so that the backup data is in a standard file with the hidden/read only attribute.

The storage means can be implemented in the following ways:

1. Isomorphic storage means: The data to be backed up are stored in an equal amount of space in the selected partition.

2. Compression storage means: The data to be backed up are first compressed and the compressed data is then stored in the selected partition.

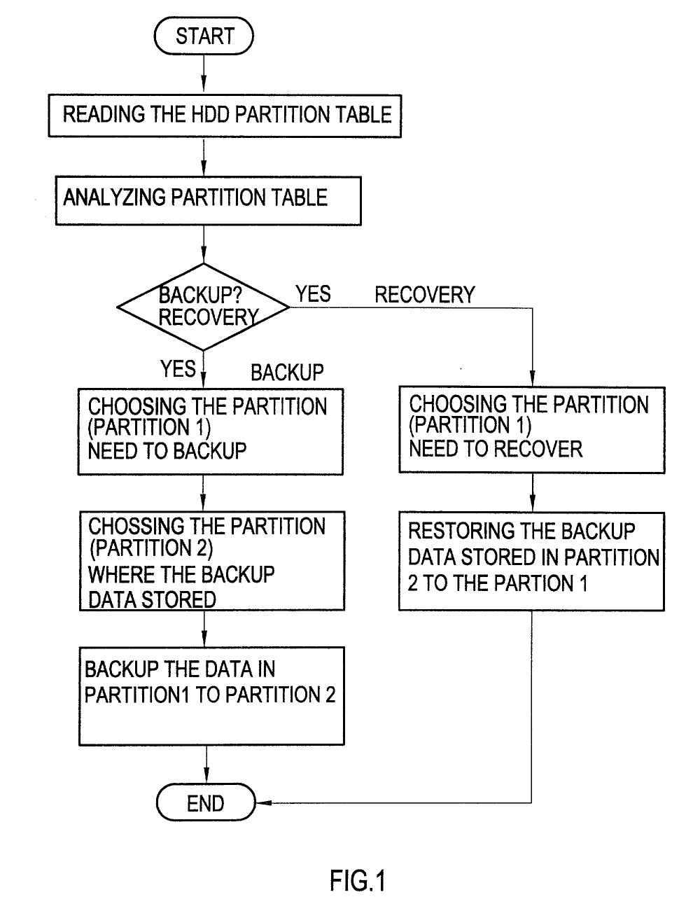

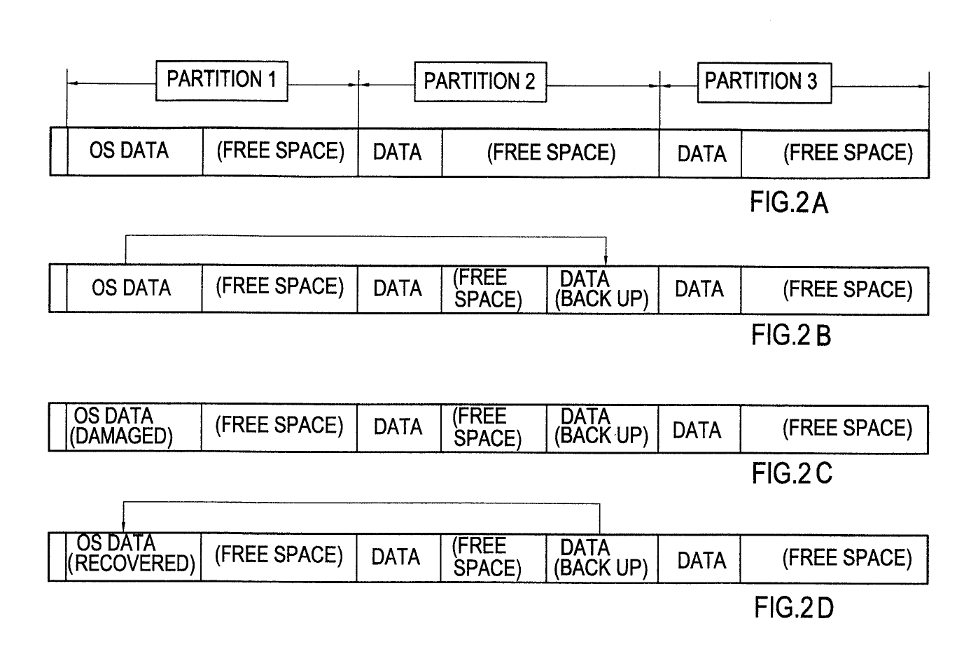

With reference to FIG. 1, the disclosed invention can be directly installed in the extension BIOS. When the computer starts the BIOS, the computer will first read the HDD partition table and analyze the capacity of each partition in the HDD (FIG. 2A). The system further checks whether at least two identical OS files exist in the HDD, thus determining whether the OS data backup in an appropriate partition is needed. More specifically, if there is only one copy of the OS data is in the HDD, the disclosed method immediately performs system file backup according to the available capacity of each partition. As shown in FIG. 2B, if OS data is found only in partition 1 in the three partitions and partition 2 still has available space greater than required to store the OS data, the OS data in partition is then backed up in the remaining space of partition 2.

If the original OS is unable to start (FIG. 2C), the backup OS data is then restored to the partition where the original OS is located (FIG. 2D), and the newly recovered OS is executed. Using this method can properly back up the OS data, avoiding the situations of a crashed system due to damaged OS data.

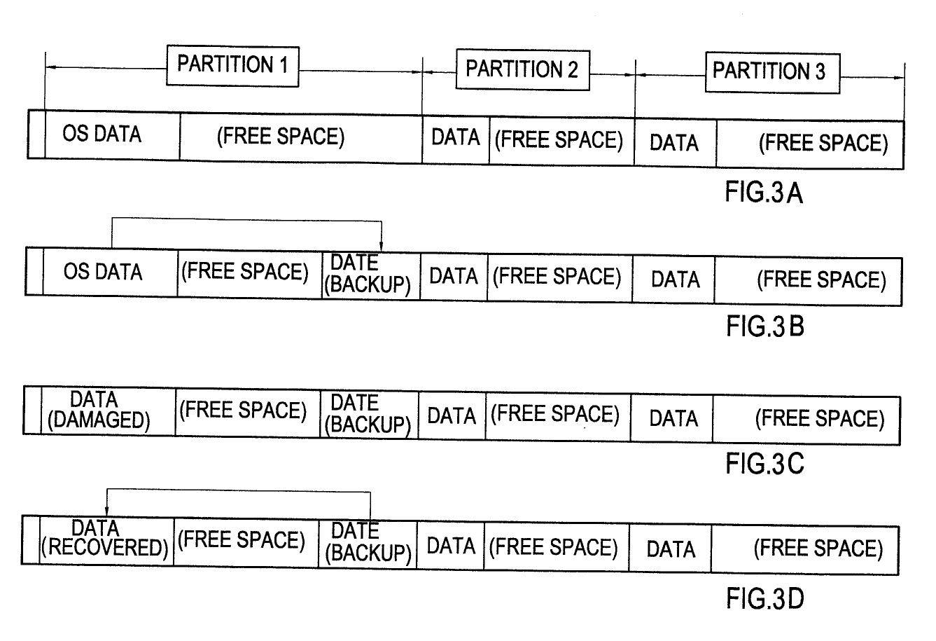

With reference to FIGS. 3A through 3D, another embodiment of the HDD data backup and recovery method backs up the OS data in partition 1 in the remaining space of the same partition 1. If the *data in partition 1 is damaged, the backup OS data can be restored to the original location of the *data.

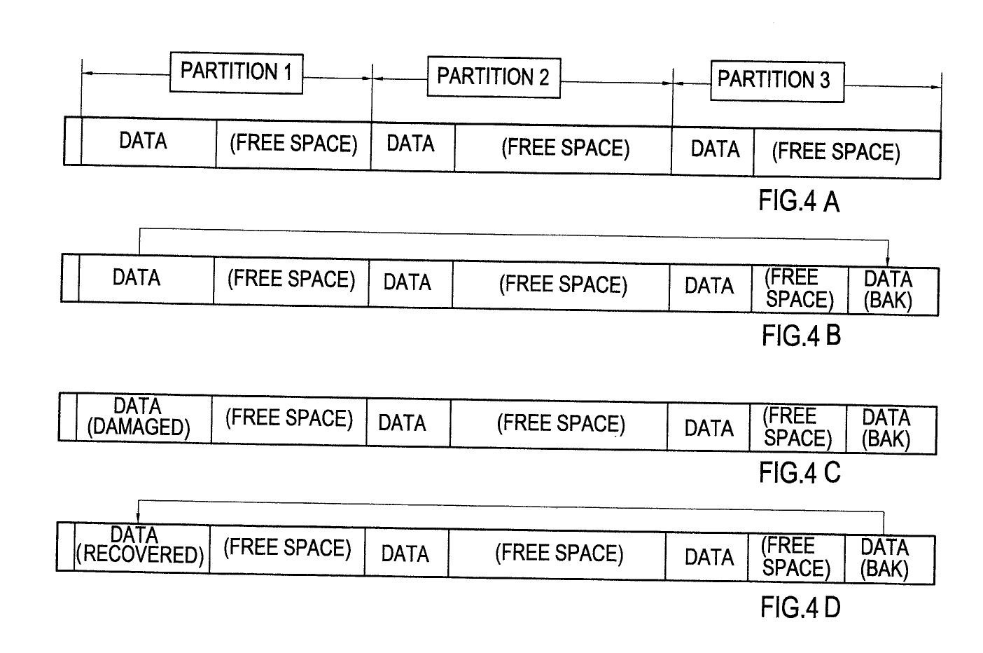

Analogously, in FIGS. 4A through 4D, the remaining space in partition 3 is sufficient for storing the data in partition 1. Therefore, partition 3 can keep another copy of the OS data. If the *data in partition 1 is damaged, the backup data in partition 3 can be restored to the original location of the *data.

From the foregoing description, one sees that the invention can utilize the remaining space in any partition of the HDD to back up the OS data. When the OS is damaged, it can immediately recover the files and restart the system. Since the disclosed program can be installed in the extension BIOS, there is no need to start a specific OS to perform the OS backup. That is, the backup and recovery actions are completed while the system is booting. Using this method, the user does not need to prepare another floppy disk or CD-ROM that stores the OS data while is still able to perform OS data backup and recovery within the HDD.

The invention may be varied in many ways by a skilled person in the art. Such variations are not to be regarded as a departure from the spirit and scope of the invention, and all such modifications are intended to be included within the scope of the following claims.

What is claimed is:

1. A HDD (Hard Disk Drive) data backup and recovery method, comprising the acts of:
reading a HDD partition table;
analyzing the HDD partition table and displaying the capacity and available space of each partition in the partition table;
determining whether data backup should be performed by checking whether two identical OSs (Operating System) exist in the HDD and, when only one OS exists in a main partition of the HDD, backing up the only OS in the remaining space of the same HDD;
determining whether the OS is damaged by checking the integrity of the OS and restoring the previous backup data to where the original copy of the OS is located in the main partition if the original copy of the OS is damaged and unable to start; and
starting the OS restored in the main partition.

2. The method of claim 1, wherein the step of backing up the only OS in the remaining space of the same HDD when only one OS exists in a main partition of the HDD selects an appropriate partition according to the data (capacity and available space) in each partition so as to store the backup data in the appropriate partition through a storage means.

3. The method of claim 2, wherein the partition that stores the backup data is made to have a decreased capacity.

4. The method of claim 2, wherein the partition that stores the backup data is tagged to be a damaged track/sector.

5. The method of claim 2, wherein the partition that stores the backup data is made to have a hidden/read only attribute.

6. The method of claim 2, wherein the storage means is an isomorphic storage means that stores the data to be backed up in an equal amount to the selected partition.

7. The method of claim 2, wherein the storage means is a compression storage means that first compresses the data to be backed up and then stores the compressed data in the selected partition.
